(19) United States
(12) Patent Application Publication
(10) Pub. No.: US 2012/0014292 A1
(43) Pub. Date: Jan. 19, 2012

(54) Access Management System and Access Management Method

(75) Inventors: Koitiro Okabe, Tokyo (JP); Hitoshi Nozaki, Kanagawa (JP); Kazuhiko Mori, Tokyo (JP)

(73) Assignees: INTEC INC., Toyama (JP); TIS INC., Tokyo (JP)

(21) Appl. No.: 13/240,619

(22) Filed: Sep. 22, 2011

Related U.S. Application Data
(63) Continuation of application No. PCT/JP2011/059118, filed on Apr. 12, 2011.

(30) Foreign Application Priority Data
Apr. 12, 2010 (JP) 2010-091795

(51) Int. Cl. H04W 4/16

(52) U.S. Cl. 370/259

(57) ABSTRACT

An access management system includes a Web page providing unit transmitting a Web page to a user terminal, a contact accepting unit receiving information purporting a request for the contact from the user terminal, a contact information generating unit setting information of the Web page browsed by the user as access information, a contact number issuing unit issuing a phone number for contact which is associated with the access information, a first talk control unit making a call to a phone of the user, a second talk control unit making the call to a phone of a call recipient which is associated with the access information a connection control unit connecting the call of the phone of the user to the call of the phone of the call recipient, and an access information providing unit transmitting the access information to a terminal provided at the call recipient.

### CROSS-REFERENCE TO RELATED APPLICATION

The present application is a continuation of International Patent Application No. PCT/JP2011/059118, filed on Apr. 12, 2011, now pending, the contents of which are herein wholly incorporated by reference.

### FIELD

The present invention relates to a technology of managing an access to a Web site and an access via a phone, etc., in a way that associates these accesses with each other.

### BACKGROUND

Over the recent years, there has been a wide spread of the World Wide Web (which will hereinafter be abbreviated to WWW and simply referred to also as the Web) provided on the Internet, via which a variety of documents, i.e., so-called Web pages are provided from all quarters such as enterprises, public institutions and individuals, and the Web has become one of major media.

A client terminal requests a Web server for a document, i.e., a Web page specified by URL (Uniform Resource Locator), at which time the Web server transmits the specified Web page to the client terminal as a requester.

In this case, communications between the Web server and the client terminal are completed and stateless at a point of time when the Web server transmits back the Web page in response to a request of the client terminal, and hence, even when the client terminal requests, e.g., a next Web page, the Web server cannot recognize that the request is received from the same client terminal.

Such being the case, the Cookie is standardized (RFC2965) for identifying the client terminal.

The client terminal is identified by use of a Cookie, thereby enabling the Web server to manage information such as a log-in status of the client terminal and a cart status at a shopping site.

For instance, in the case of approving only an already-authenticated client terminal (user) to browse the Web page at, e.g., a Web site of a membership system, a session ID is issued as a Cookie to the authentication-succeeded client terminal undergoing authentication for the first time, and, if this session ID is attached to the subsequent Web page request, the request can be recognized as the request given from the already-authenticated client terminal, whereby the Web page is provided without newly authenticating because the request can be recognized as the request from the already-authenticated client terminal. In addition, a variety of services can be provided by use of Cookies.

Cookies are widely utilized and usable on a great majority Web Browsers but are not used other than WWW. For example, Cookies cannot be used for a voice talk by phone and FAX-based communications (which will hereinafter be referred to as accesses via the phone, etc.). Accordingly, in a case where the user telephones by seeing a phone number registered on the Web page, the Web server side cannot grasp the access information via the phone, etc.

Note that such a system (Patent document 1) is proposed that the phone number containing identifying information is described in advertisement information registered on the Web page, and the phone number containing the identifying information is dialed from a first phone, in which case a calling connection device for relaying this phone call extracts the identifying information from the phone number and connects the first phone to a second phone corresponding to the phone number of the call recipient which is associated with the identifying information.

In the description of the system of the Patent document 1, a dialing count of the calls to the phone number containing the identifying information and a period of talk time are totalized in the way of associating the advertisement information and the identifying information with each other, thereby acquiring advertising effects and advertising charges.

[Patent document 1] Japanese Patent Application Publication No.4077866

[Patent document 2] Japanese Patent Application Laid-Open Publication No.2006-112742

[Patent document 3] Japanese Patent Application Laid-Open Publication No.2006-211237

The system of Patent document 1 has such a problem that the user of the phone needs to telephone by inputting the phone number containing the identifying information, which is a time-consuming operation.

Further, the system of Patent document 1 is a system in which the phone number containing the identifying information is registered together with the advertisement information on the Web page, then the user, who telephoned, is assumed to see the advertisement information, and it follows that the user seeing the same advertisement (Web page) dials the same phone number, while the user (client terminal) cannot be individually recognized as by Cookie.

Moreover, in the system of Patent document 1, as to not only a case where the user has a direct access to the Web site by using the client terminal and telephones by seeing the Web page registered with the phone number but also a case of telephoning without accessing the Web site, a case of telephoning by seeing, e.g., a printed Web page and a case of telephoning by seeing the Web page existing in a cache of a search engine etc, the above items are similarly totalized, and therefore the access to the Web site and the access via the phone are not associated as by Cookie.

Under such circumstances, it is an object of the present invention to provide a technology of associating the access of a specified user to the Web site with the access via the phone.

### SUMMARY

For accomplishing the object described above, an access management system according to the present invention includes: a Web page providing unit transmitting a Web page to a user terminal when receiving a request for browsing the Web page from the user terminal by a user's operation; a contact accepting unit receiving, when the user selects an option of a contact by phone in options described on the Web page, information purporting a request for the contact from the user terminal; a contact information generating unit setting, when receiving the information purporting the request for the contact, at least information of the Web page browsed by the user as access information; a contact number issuing unit issuing a phone number for contact which is associated with the access information; a first talk control unit making a call to a phone of the user on the basis of the user's phone number specified by an input operation of the user and notifying of the contact phone number as an originator number or receiving a call originated from the phone of the user and addressed to the contact phone number; a second talk control unit making the call to a phone of a call recipient which is associated with the access information; a connection control unit connecting the call of the phone of the user to the call of the phone of the call recipient; and an access information providing unit transmitting the access information to a terminal provided at the call recipient via a network.

When the first talk control unit receives the call addressed to the contact phone number from the phone of the user, the second talk control unit may make the call to the phone of the call recipient which is associated with the contact phone number, and the connection control unit may connect the call of the first talk control unit to the call of the second talk control unit.

The contact number issuing unit may issue a contact phone number for the call recipient, which is different from the contact phone number associated with the access information in the way of being associated with the access information.

The access information providing unit may transmit the access information to a facsimile terminal provided at the call recipient via a telephone line.

Further, an access management method according to the present invention is a method by which a computer executes: a step of transmitting a Web page to a user terminal when receiving a request for browsing the Web page from the user terminal by a user's operation; a step of receiving, when the user selects an option of a contact by phone in options described on the Web page, contact request information from the user terminal; a step of setting, when receiving the contact request information, at least information of the Web page browsed by the user as access information; a step of issuing a phone number for contact which is associated with the access information; a step of making a call to a phone of the user on the basis of the user's phone number specified by an input operation of the user and notifying of the contact phone number as an originator number or receiving a call originated from the phone of the user and addressed to the contact phone number; a step of making the call to a phone of a call recipient which is associated with the access information; a step of connecting the call of the phone of the user to the call of the phone of the call recipient; and a step of transmitting the access information to a terminal provided at the call recipient via a network.

Moreover, in the access management method according to the present invention, when receiving the call addressed to the contact phone number from the phone of the user, the call may be given to the phone of the call recipient which is associated with the contact phone number, and the call of the user terminal may be connected to the call of the phone of the inquired party.

Furthermore, in the access management method according to the present invention, a contact phone number for the call recipient, which is different from the contact phone number associated with the access information, may be issued for the call recipient in the way of being associated with the access information.

Still further, in the access management method according to the present invention, the access information may be transmitted to a facsimile terminal provided at the call recipient via a telephone line.

It should be noted that the phone number for contact in the present application is the phone number as Cookie so that this contact phone number can be used for the phone by associating the phone number with the access information owing to the configuration described above, in which Cookie is exemplified by PhoneCookie (a trademark, the same is applied to the following description and the drawings as well).

[Effects of the Invention]

The system disclosed herein can provide the technology of associating the access of the specified user to the Web site with the access via the phone on the basis of the Web page.

### BRIEF DESCRIPTION OF DRAWINGS

FIG. 1 A schematic diagram of an access management system.

FIG. 2 A schematic diagram of a Web server.

FIG. 3 A schematic diagram of an application server.

FIG. 4 A schematic diagram of a call control device.

FIG. 5 An explanatory flowchart of an access management method.

FIG. 6 A diagram showing one example of a Web page.

FIG. 7 A diagram showing pieces of information associated with PhoneCookie.

FIG. 8 An explanatory flowchart of the access management method.

FIG. 9 A flowchart showing a modified example of the access management method.

FIG. 10 A flowchart showing another modified example of the access management method.

FIG. 11 A schematic diagram of the access management system according to a second embodiment.

FIG. 12 A flowchart illustrating the access management method. According to the second embodiment.

FIG. 13 An explanatory diagram of the access management method according to the second embodiment.

FIG. 14 An explanatory diagram of the access management method according to a first modified example of the second embodiment.

FIG. 15 An explanatory diagram of the access management method according to a second modified example of the second embodiment.

FIG. 16 An explanatory diagram of the access management method according to a third modified example of the second embodiment.

### DESCRIPTION OF EMBODIMENTS

A best mode for carrying out the present invention will hereinafter be described with reference to the drawings. Configurations in the following embodiments are exemplifications, and the present invention is not limited to the configurations in the embodiments.

### First Embodiment

### <System Architecture>

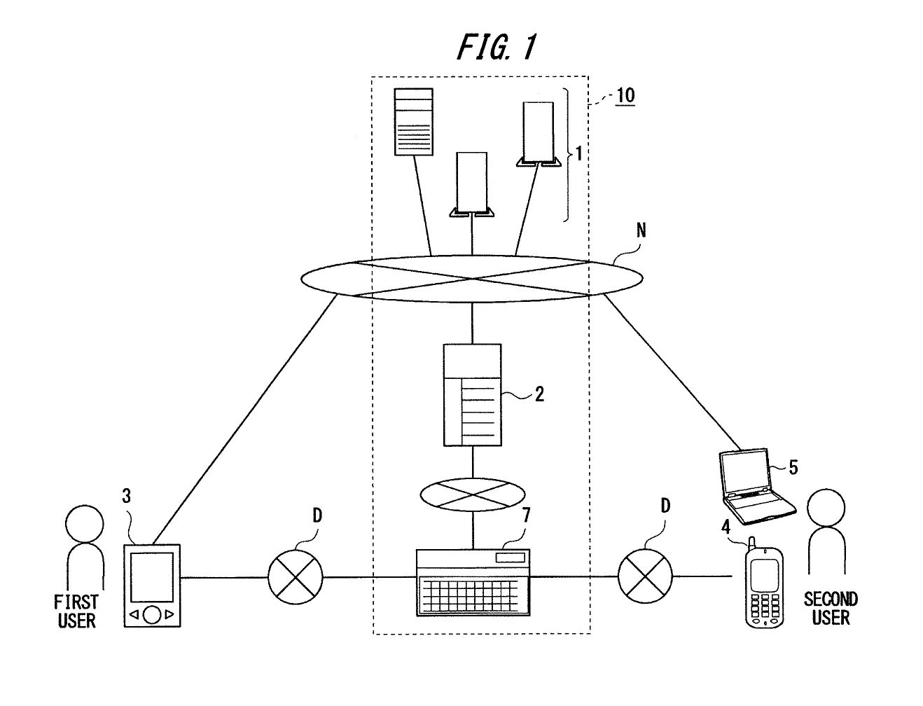

FIG. 1 is a schematic view of an access management system according to the present invention. An access management system 10 in the first embodiment includes a Web server 1, an application server 2 and a call control device 7.

A user terminal 3 has a function as a client terminal which browses a Web (Web pages) via a network N such as the Internet and transmits and receives an electronic mail (e-mail), and further has a function as a telephone used for performing a voice talk via a telephone line D. Note that the user terminal 3 may be, without being limited to what integrally incorporates the function as the client terminal and the function as the telephone, configured so that the client terminal is separated from the telephone.

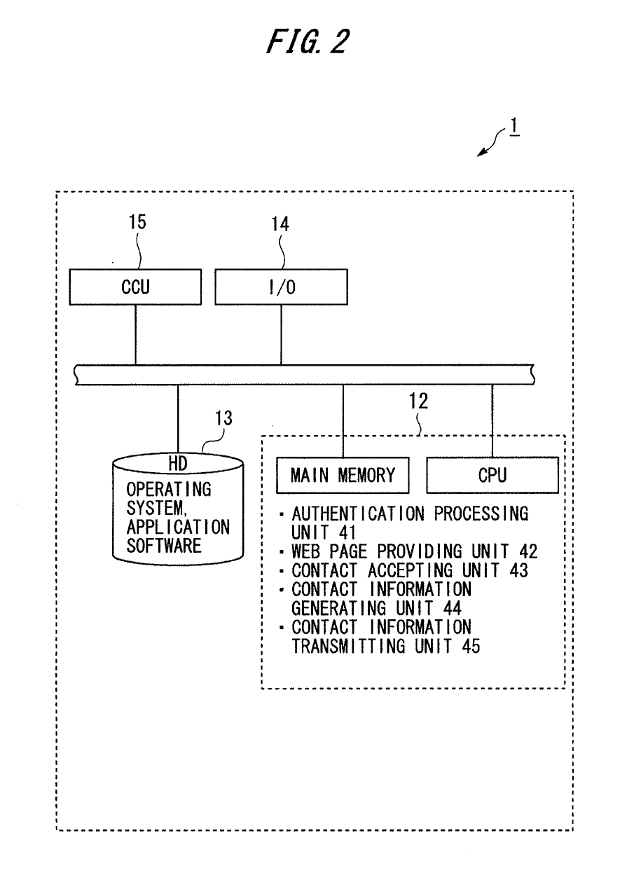

FIG. 2 is a schematic diagram of a configuration of the Web server 1 in the first embodiment. As shown in FIG. 2, the Web server 1 is a computer including an arithmetic processing unit 12 constructed of a CPU (Central Processing Unit), a main memory, etc, a storage unit (hard disk) 13 stored with data and software for an arithmetic process, an input/output interface 14, a communication control unit (CCU) 15 and so on.

The I/O interface 14 is an interface which is connected to input/output means and inputs and outputs signals. A console (including a keyboard and a display), a reading/writing device for a storage medium, etc are properly connected as the I/O means to the I/O interface 14.

The CCU 15 establishes connections with other computers via the network N and controls communications with other computers in response to an instruction given from the CPU.

The storage unit 13 is preinstalled with pieces of software such as an operating system (OS) and application software (a server program) and is stored with data of Web pages configuring a Web site. Further, the storage unit 13 is stored with user information such as registration data for authenticating users and telephone numbers of the users and thus functions also as a user information storage unit.

The arithmetic processing unit 12 properly reads the OS and the application program from the storage unit 13, then executes the OS and the application program, and carries out the arithmetic process of the information inputted from the I/O interface 14 and from the CCU 15 and the information read from the storage unit 13, thereby functioning also as an authentication processing unit (module) 41, a Web page providing unit (module) 42, a contact accepting unit (module) 43, a contact information generating unit (module) 44 and a contact information transmitting unit (module) 45.

The authentication processing unit 41, when receiving a request for a Web page which requires the authentication from the user terminal 3, determines whether the user terminal 3 has already been authenticated or not, transmits an authentication screen to the user terminal 3 to get the user terminal 3 to display this authentication screen in which to prompt the user to input items of authentication information such as ID (identification) and a password if not yet authenticated, then compares the ID and the password inputted to the authentication screen with authentication information registered in the storage unit 13, deems that the user terminal 3 has already been authenticated if coincident with each other, and issues a session ID as an HTTP (HyperText Transfer Protocol) cookie.

The Web page providing unit 42, when receiving a request for browsing the Web page specified by a URL (Uniform Resource Locator) from on the user terminal 3, reads this specified Web page out of the storage unit 13 and transmits the Web page to the user terminal 3.

The contact accepting unit 43 receives information purporting contact notifications such as a query-by-phone and an application-by-phone from the user terminal 3. For example, a link for the phone contact is registered as an option described in Markup language such as HTML (HyperText Markup Language) and XML (eXtensible Markup Language) on the Web page provided to the user terminal 3, in which the user selects this link, and the contact accepting unit 43, when the Web page specified by a predetermined URL is requested, recognizes that the phone contact request is received. Note that another available configuration involves, without being limited to the selection of the link, receiving the request for the phone contact corresponding to a user's operation such as selecting a button and checking a check box. Herein, the user terminal 3 has already been authenticated and holds the session ID as the HTTP cookie, in which case the user terminal 3 notifies of the session ID together with the request for the predetermined URL. It is to be noted that the phone contact request may be, without being limited to the request which involves thus transmitting the predetermined URL, a request which involves transmitting the information simply representing the phone contact and may also be a request which involves starting up a predetermined cgi (common gateway interface: CGI scripts).

The contact information generating unit 44 sets at least information on the Web page browsed by the user as access information of the user. For example, the contact information generating unit 44 specifies, based on the session ID received together with the phone contact request, the URL etc of the Web page browsed by the user, especially the Web page registered with the link (option) for the phone contact. If the user browses a plurality of Web pages, the URLs of these Web pages and logs of a browsing sequence and a browsing date/time, etc may be set as access information. Moreover, items of information inputted to and selected on the browsed Web pages such as data inputted to input boxes of the Web pages and information written when selecting a purchase button on a shopping site, may also be set as the access information. Further, the access information may also be contents described on the Web page. For instance, in the case of the Web page concerning introductions and purchases of commercial articles, names and IDs of the commercial articles are set as the access information. In this case, an available configuration is that there is read the access information such as the names and IDs of the commercial articles, which are stored beforehand in the storage unit 13 in the way of being associated with the Web page, and another available configuration is that a title, a header, a character string specified by specific tags (tag set), etc are extracted from the Web page.

Furthermore, the contact information generating unit 44 reads a phone instruction parameter associated with the link for the phone contact from the storage unit 13. Note that the phone instruction parameter is defined as a parameter indicating a phone number of a call recipient and an operation after talking, and is previously stored in the storage unit 13 in the way of being associated with the link for the phone contact. Namely, when the link for the phone contact is selected, the associated phone number etc of the call recipient is read.

Further, the contact information generating unit 44 identifies the user on the basis of the session ID and reads the user information such as the phone number etc of the user from the storage unit 13. To be specific, in the first embodiment, the phone number of the user is specified from membership information associated with the ID inputted by the user's input operation when authenticated. Further, the contact information generating unit 44 adds the user information such as the phone number etc of the user to the phone instruction parameter.

Then, the contact information generating unit 44 generates contact request information containing the access information and the call recipient information (the phone instruction parameter).

The contact information transmitting unit 45 transmits the contact request information generated by the contact information generating unit 44 to the application server 2.

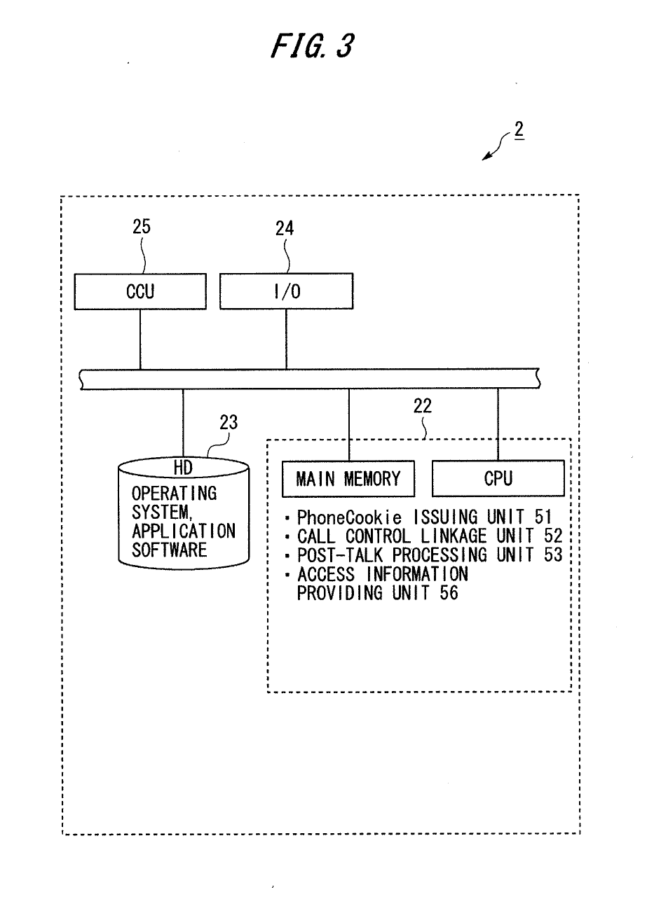

FIG. 3 is a schematic diagram of a configuration of the application server 2. As shown in FIG. 3, the application server 2 is a computer including an arithmetic processing unit 22 constructed of the CPU (Central Processing Unit), the main memory, etc, a storage unit (hard disk) 23 stored with the data and the software for the arithmetic process, an input/output interface 24, a communication control unit (CCU) 25 and so on.

The I/O interface 24 is an interface which is connected to the input/output means and inputs and outputs the signals. The console (including the keyboard and the display), the reading/writing device for the storage medium, etc are properly connected as the I/O means to the I/O interface 24.

The CCU 25 establishes the connections with other computers via the network N and controls the communications with other computers in response to the instruction given from the CPU.

The storage unit 23 is preinstalled with pieces of software such as the operating system (OS) and the application software (an access management program) and is stored with data of the call recipients.

The arithmetic processing unit 22 properly reads the OS and the application program from the storage unit 23, then executes the OS and the application program, and carries out the arithmetic process of the information inputted from the I/O interface 24 and from the CCU 25 and the information read from the storage unit 23, thereby functioning also as a PhoneCookie issuing unit (module) 51, a call control linkage unit (module) 52, a post-talk processing unit (module) 53 an access information providing unit (module) 56.

The PhoneCookie issuing unit 51, when receiving the contact request information from the Web server 1, issues a contact phone number associated with the contact request information. This contact phone number is, as will be described later on, a phone number serving as PhoneCookie ensured for the call control device so that the call control device 7 receives an incoming call when the user terminal 3 or a phone 4 of the call recipient makes a call to this phone number. For example, in the case of using a 11-digit phone number such as “050-ABCD-xxxx”, the phone numbers given 10000-ways ranging from the last 4 digits “0000” to the last 4 digits “9999” are ensured. Namely, if the first 7 digits are “050-ABCD”, the last 4 digits take whatever numbers, all of the calls arrive at the call control device. Accordingly, even when the user is notified of the last 4 digits which undergo numbering unrestrictedly, the call control device 7 can answer all of the phone calls to this number. Thus, the plurality of phone numbers for the call control device 7 is ensured, and the PhoneCookie issuing unit 51 allocates, as PhoneCookie, one of the phone numbers for the call control device 7 to each piece of contact request information and makes unique each PhoneCookie among all PhoneCookies allocated to the contact request information. Namely, the contact request information corresponding to PhoneCookie can be uniquely specified.

The call control linkage unit 52 transmits an instruction of performing the call control based on the contact request information to the call control device 7. For instance, in the case of receiving the contact request information from the Web server 1, the call control linkage unit 52 transmits, to the call control device 7, a command for establishing the call (connection) between the user and the callee of the call recipient the phone instruction parameter containing the phone number of the user and the phone number of the call recipient.

Further, the call control linkage unit 52, when the call control device 7 notifies the call control linkage unit 52 that the talk is finished, informs the post-talk processing unit 53 of this purport and gets the post-talk processing unit 53 to execute a post-talk process.

The post-talk processing unit 53, in the case of receiving a talk finishing notice from the call control linkage unit 52, executes the post-talk process based on a post-talk parameter in the phone instruction parameter. For example, related pieces of information accompanying the phone contact, e.g. an expression of gratitude, a material (support information), information on related commercial articles and a map such as [Thank you for your query.], [Concerning the BIOS update method you inquired about, conduct the following procedures, please.], [We deal with the following commercial articles related to the commercial article you inquired about.] and [We will send you a map of the reception counter.], are transmitted to the address of the user terminal 3 by e-mail after the talk.

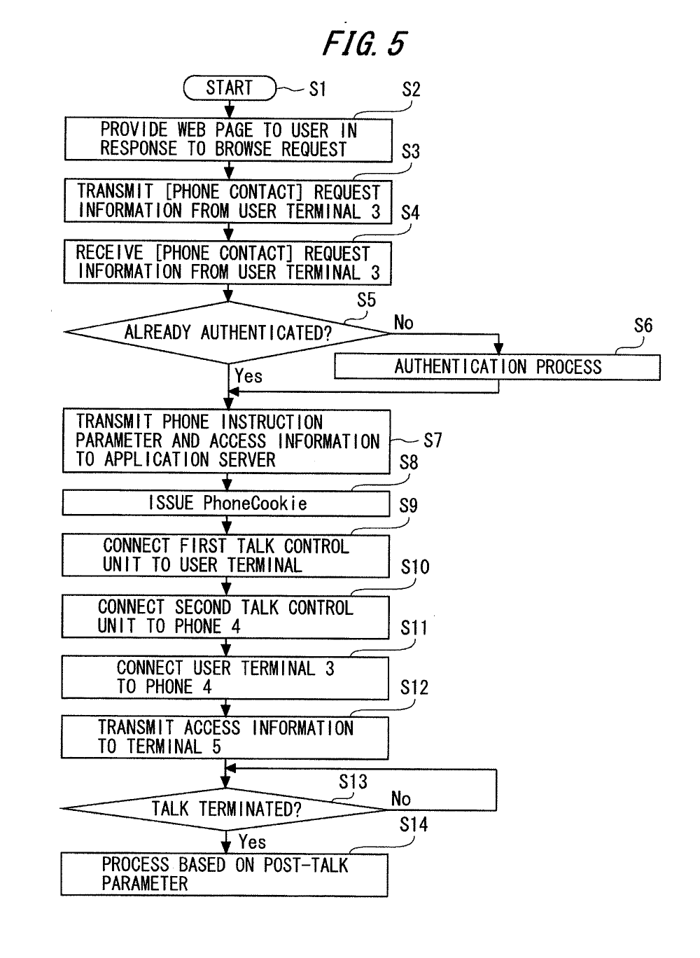

The access information providing unit 56 transmits the information on the query such as the access information and the user information (which will hereinafter be generically referred to also as the access information etc) to the terminal 5 (FIG. 5) of the call recipient via the network N. Further, the access information etc (the query-related information) may contain the information stored beforehand in the storage unit 13 in the way of being associated with the access information and the user information, e.g., specifications and Q&A associated with the commercial article ID registered on the browsed Web page and a purchase history of the user. This scheme enables a person-in-charge of the call recipient to check the Web page browsed by the user as the phone contact requester when making the request and the data inputted to this Web page on the terminal 5 at hand.

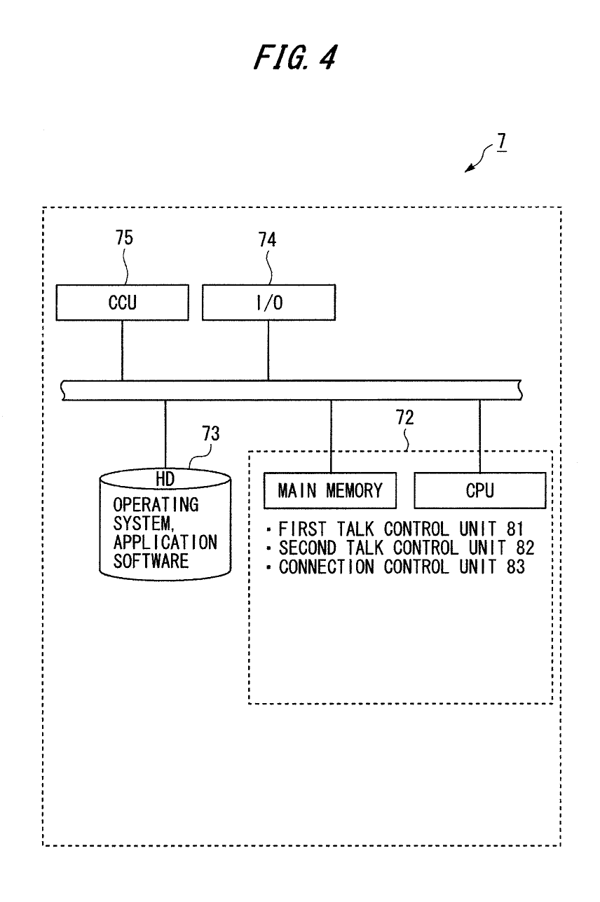

On the other hand, the call control device 7 is a device which controls the call between the phones via a telephone network D. In the first embodiment, the call control device 7 is defined as a CTI (Computer Telephony Integration) server which controls the call between the phones on the basis of SIP (Session Initiation Protocol). It should be noted that the call control device 7 in the first embodiment may be, if capable of controlling the call in response to the instruction given from the application server 2, a telephone exchange in another system without being limited to the SIP server. FIG. 4 is a schematic diagram of a configuration of the call control device 7. As illustrated in FIG. 4, the call control device 7 is a computer, i.e., the so-called CTI server including an arithmetic processing unit 72 constructed of the CPU (Central Processing Unit), the main memory, etc, a storage unit (hard disk) 73 stored with the data and the software for the arithmetic process, an input/output interface 74, a communication control unit (CCU) 75 and so on.

The I/O interface 74 is an interface which is connected to the input/output means and inputs and outputs the signals. The console (including the keyboard and the display), the reading/writing device for the storage medium, etc are properly connected as the I/O means to the I/O interface 74.

The CCU 75 establishes the connections with other devices via the telephone network D and controls the communications in response to an instruction given from the CPU. The CCU 75 in the first embodiment performs the communications based on the SIP and controls the calls of the phone 4 and the user terminal 3 via a VoIP (Voice over Internet Protocol) gateway and a wireless base station within the telephone network D. For example, the VoIP gateway within the telephone network D accommodates the phone 4, converts a voice signal and a control signal into a VoIP packet and transmits this VoIP packet to the call control device 7. Moreover, the VoIP packet transmitted to the phone 4 from the call control device 7 is converted back into the voice signal and the control signal by the VoIP gateway and transmitted to the phone 4. Further, the wireless base station accommodates the user terminal 3 via a mobile phone line, converts the voice signal and the control signal sent from the user terminal 3 into the VoIP packet and transmits the VoIP packet to the call control device 7. Moreover, the VoIP packet transmitted to the user terminal 3 from the call control device 7 is converted back into the voice signal and the control signal by the wireless base station and transmitted to the user terminal 3.

The storage unit 73 is preinstalled with pieces of software such as the operating system (OS) and the application software.

The arithmetic processing unit 72 properly reads the OS and the application program from the storage unit 73, then executes the OS and the application program, and carries out the arithmetic process of the information inputted from the I/O interface 74 and from the CCU 75 and the information read from the storage unit 73, thereby functioning also as a first talk control unit (module) 81, a second talk control unit (module) 82 and a connection control unit (module) 83.

The first talk control unit 81 makes the call to the phone of the user, i.e., the user terminal 3 on the basis of the user information, and notifies the user terminal 3 of PhoneCookie as a caller number.

The second talk control unit 82 makes the call to the call recipient associated with the access information, e.g., the phone 4 of a member's store or the phone 4 of an administrator of the Web site, and notifies the callee of PhoneCookie as a caller number.

The connection control unit 83 receives an instruction of the call control from the application server 2, controls the first talk control unit 81 and the second talk control unit 82 in accordance with this instruction, and performs the call control of the user terminal 3 and the phone 4 of the call recipient. For instance, the voice data received by the first talk control unit 81 via the call with respect to the user terminal 3 is transmitted to the phone 4 from the second talk control unit 82 via the call with respect to the phone 4, and the voice data received by the second talk control unit 82 via the call with respect to the phone 4 is transmitted to the user terminal 3 from the first talk control unit 81 via the call with respect to the user terminal 3, thereby enabling the user terminal 3 and the phone 4 to talk with each other. Note that a process of connecting these two calls is so-called third party control and can involve using the known technology, and hence an in-depth description thereof is omitted.

Further, the connection control unit 83, when receiving a talk termination signal and a disconnection signal of the talk undergoing the call control, disconnects the call and notifies the call control linkage unit 52 of the application server 2 that the talk is terminated.

### <Management Method>

Next, an access management method executed by the access management system will be described with reference to FIGS. 5-8.

To begin with, the user registers the membership in the Web server 1. For example, items of user information such as the name, the phone number, the ID and the password of the user are transmitted to and stored in the Web server 1.

Moreover, the administrator of the Web server 1 describes the phone contact, e.g., the link (option) to [query-by-phone] on the Web page to be provided and, when the user desires for the contact and selects the link while browsing, performs setting so that the URL described as a link destination is transmitted to the Web server 1.

Further, the storage unit 13 is configured to get stored with pieces of information of the call recipient (contact information) in which to specify the phone number of the person-in-charge of the call recipient, the phone number of the store, a post-talk action and an on-talk action as the phone instruction parameters in the way of being associated with the link destination. For instance, in the case of the link destination registered in the page of the guidance to the commercial articles, the phone number of the person in charge of sales is associated as the call recipient (contact information) with this link; in the case of the link destination registered on the page for settlement, the phone number of the person in charge of accounting is associated as the call recipient (contact information) with this link; and in the case of the link destination registered on the page in which to input a delivery destination, the phone number of the person in charge of delivery is associated as the call recipient (contact information) with this link.

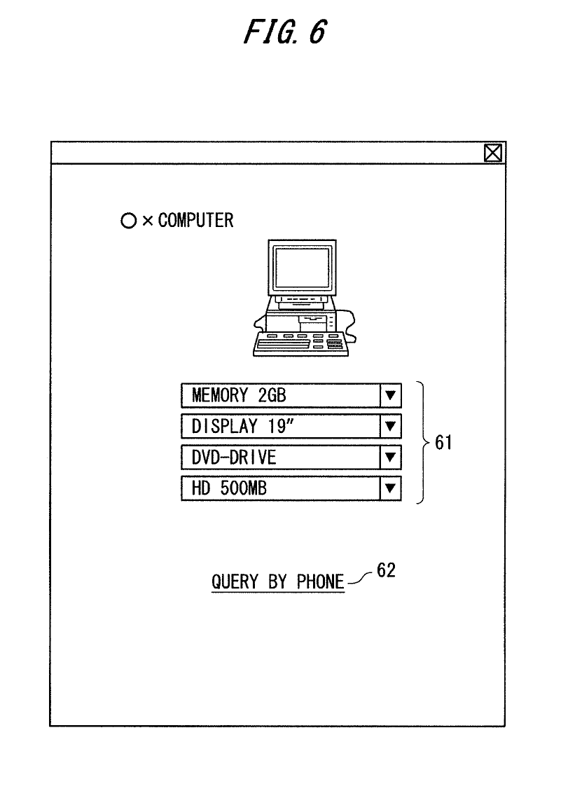

Then, as shown in FIG. 5, the administration of the Web site is initiated (step S1), and the user terminal 3 makes a request for browsing the Web page in a way that specifies the URL, at which time the Web page providing unit 42 of the Web server 1 provides the Web page specified by the URL to the user terminal 3, whereby the Web page is displayed on the user terminal 3 (step S2). FIG. 6 is a diagram showing a display example of this Web page. FIG. 6 illustrates the example of the page for purchasing the commercial articles, in which an input box 61 for inputting options and a [phone contact] link 62 are inserted.

When the link 62 is selected, the user terminal 3 transmits the request based on the parameter of the link 62, i.e., the information for requesting the [phone contact] to the Web server 1 (step S3).

The contact accepting unit 43, when receiving the information purporting the request for the contact by phone from the user terminal 3 (step S4), determines, based on whether or not the session ID issued by the authentication processing unit 41 is received from the user terminal 3, whether the user terminal 3 has already been authenticated or not (step S5). If not already authenticated, the authentication processing unit 41 displays a log-in screen, then prompts the user to input the ID and the password, and executes the authentication process (step S6).

If already authenticated in step S5 and if already authenticated in step S6, the contact information generating unit 44 reads the access information associated with the session ID and the phone instruction parameter associated with the link destination from the storage unit 13, and generates and transmits the contact request information to the application server 2 (step S7). Note that the access information may be information on the user's access to the Web server 1 such as the URL of the Web page on which the [query by phone] link is selected, the data inputted to the Web page and the user's browse history of the Web page.

The PhoneCookie issuing unit 51 of the application server 2, which receives the contact request information from the Web server 1, issues a unique phone number corresponding to the contact request information as PhoneCookie (step S8).

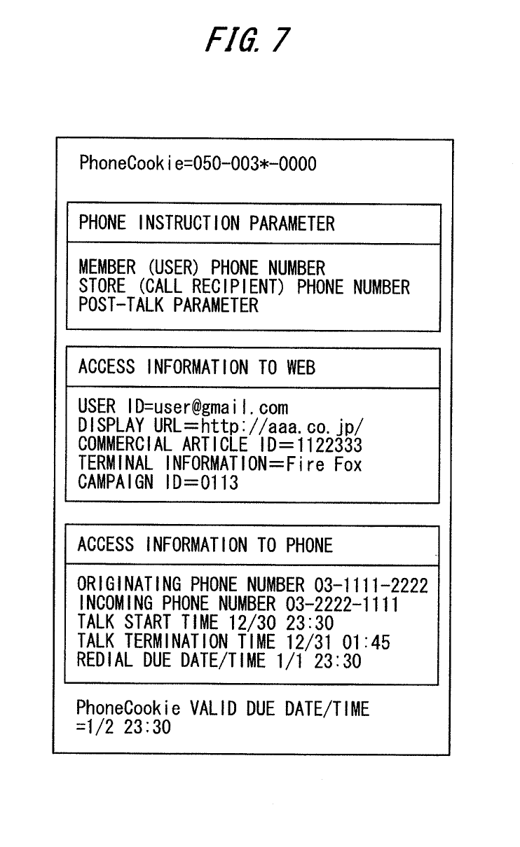

After issuing PhoneCookie, the call control linkage unit 52 of the application server 2 transmits the call control instruction together with the phone instruction parameter to the call control device 7. The first talk control unit 81 of the call control device 7 receiving the call control instruction makes the call to the user terminal 3 on the basis of the phone number of the user information, and notifies the user terminal 3 of PhoneCookie as a caller number (step S9). Note that FIG. 7 is a diagram illustrating the information associated with PhoneCookie.

Further, the second talk control unit 82 makes the call to the phone 4 of the call recipient on the basis of the phone number of the call recipient of the phone instruction parameter, and notifies the phone 4 of PhoneCookie as the caller number (step S10).

The connection control unit 83 establishes the call given by the first talk control unit 81 and the call given by the second talk control unit 82, and connects these calls, thereby setting the user terminal 3 and the phone 4 of the call recipient in a talk status (step S11).

Then, the access information providing unit 56 transmits the access information to the terminal 5 of the call recipient via the network N (step S12).

Moreover, the connection control unit 83, if the post-talk parameter is set in the phone instruction parameter, monitors the talk status, gives notification to the application server 2 when terminating the talk, and gets the post-talk processing unit 53 to execute a process based on the post-talk parameter (steps S13, S14). For example, upon a trigger of terminating the talk, a follow-up e-mail such as [Thank you for your query.] is transmitted, and a map of the store is transmitted.

Thus, according to the first embodiment, it is feasible to provide the system which carries out the contact-by-phone scheme corresponding to the access information to the Web server 1.

Further, the person-in-charge of the call recipient can respond to the contact by phone while checking the Web page browsed by the user and the input information to the Web page on the terminal 5 by transmitting the access information to the Web server 1 and the call recipient by phone to the terminal 5.

Moreover, the application server 2 can recognize the termination of the talk, and then the talk is terminated, on which occasion the post-talk process can be executed timely.

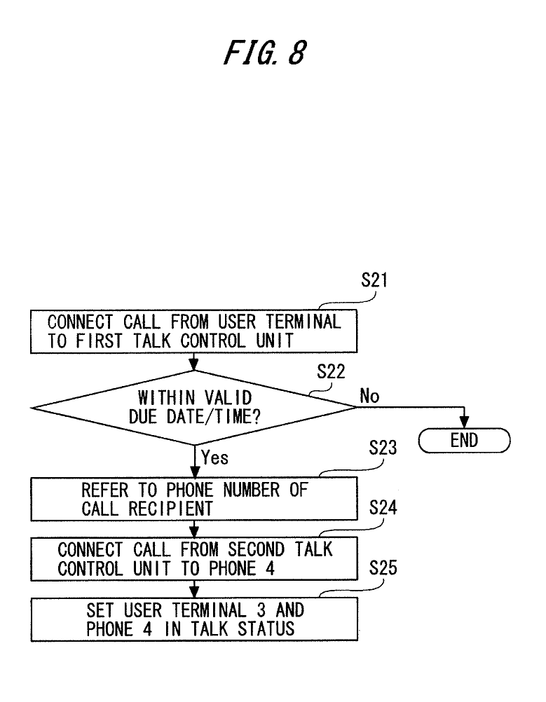

Further, FIG. 8 is an explanatory flowchart showing a case in which the user terminal 3 calls back according to PhoneCookie.

When the user terminal 3 makes the call to the phone number as PhoneCookie through the user's operation, the first talk control unit 81 of the call control device 7 receives the incoming call (step S21); then the connection control unit 83 notifies the call control linkage unit 52 of the application server 2 of a purport that there is the incoming call addressed to PhoneCookie; the call control linkage unit 52 determines with reference to the information (FIG. 7) associated with this PhoneCookie whether within a valid period or not (step S22); the call control device 7 is notified of the readout phone number of the call recipient associated with PhoneCookie if within the valid period (step S23); the second talk control unit 82 makes the call to the phone number of the call recipient (step S24); and the connection control unit 83 connects these calls, thereby setting the user terminal 3 and the phone 4 of the call recipient in the talk status (step S25).

Thus, if within the predetermined valid period, the contact operation can be performed from the side of the user terminal 3. In this case also, the configuration is that the user terminal 3 is connected to the phone 4 of the call recipient via the call control device 7, and hence the direct talk between the user terminal 3 and the phone 4 of the call recipient is not established, i.e., the via-device talk takes place.

### First Modified Example

In the first embodiment discussed above, the phone number of the user is acquired from the already-registered membership information, however, without being limited to this acquisition, the user may input the user's own phone number.

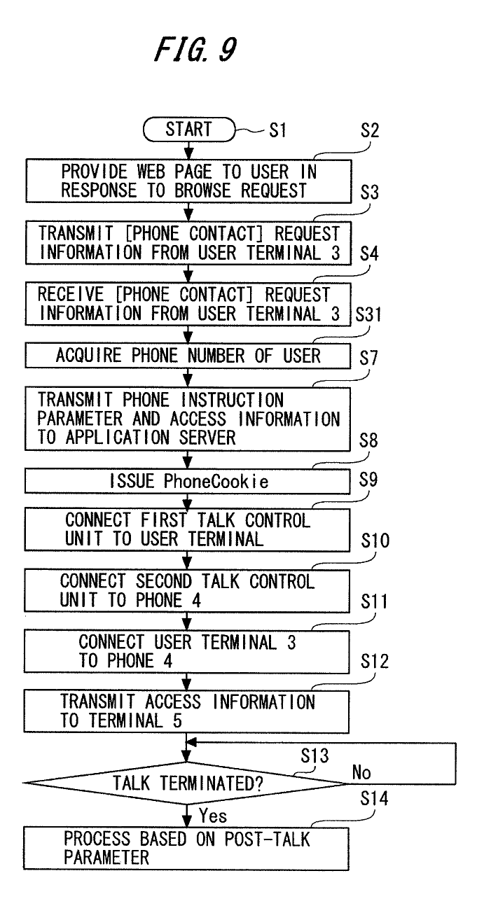

For instance, as shown in FIG. 9, when receiving the information for requesting the [phone contact] (step S4), the arithmetic processing unit (the phone number request unit) 22 of the application server 2 gets the user terminal 3 to display a message for prompting the user to input the phone number, and acquires the phone number by making the user input this phone number (step S31). Then, the Web server 1 transmits the phone instruction parameter containing this inputted user's phone number and the access information to the application server 2 (step S7), and the subsequent processes are executed in the same way as in FIG. 5.

The access management can be thereby conducted without performing the membership registration.

### Second Modified Example

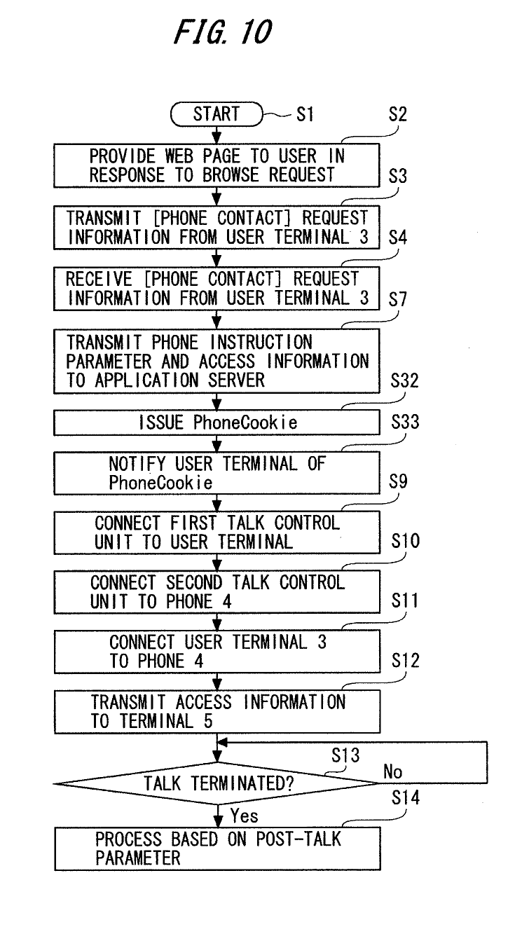

Moreover, another available scheme is that PhoneCookie is issued when requesting the [phone contact]. For example, as illustrated in FIG. 10, when receiving the information for requesting the [phone contact] (step S4), the contact information generating unit 44 transmits the phone instruction parameter and the access information, which are generically as the contact request information, to the application server 2 (S7).

The PhoneCookie issuing unit 51 of the application server 2 receiving the contact request information issues PhoneCookie associated with this contact request information, and notifies the Web server 1 of this PhoneCookie (step S32).

The Web server 1 notifies the user terminal 3 of PhoneCookie received (S33). For instance, the Web server 1 provides the Web page registered with PhoneCookie to the user terminal 3 and makes the user terminal 3 display this Web page, thereby getting the user who sees this PhoneCookie to telephone.

Further, a method of notifying the user terminal 3 is not limited to the use of the Web page, PhoneCookie received may be transmitted by e-mail to the user terminal 3.

Thus, in the case of transmitting PhoneCookie to the user terminal 3 via Web and the e-mail, if the user terminal 3 is a mobile phone or a terminal having an IP telephony function, it is desired to make a description (HTML) so as to start up the telephony function on the occasion of selecting PhoneCookie. For example, the description (HTML) is like this: <a href=“tel:050XXXXXXXX”>Telephone by Use of PhoneCookie</a>.

Then, the user, who receives the notification of PhoneCookie, operates the user terminal 3 to make the call to the phone number serving as PhoneCookie, and the first talk control unit 81 of the call control device 7 establishes the connection (establishes the call) with the user terminal 3. The subsequent processes proceed in the same way as in FIG. 5 such that the second talk control unit 82 establishes the connection (establishes the call) with the phone 4 as the inquired party (device) (step S10), and the connection control unit 83 sets the user terminal 3 and the phone 4 in the talk status by connecting these calls.

Thus, according to the second modified example, the access management can be conducted without acquiring the phone number of the user.

Note that the PhoneCookie issuing unit 51 is provided in the application server 2 in the example discussed above, however, this PhoneCookie issuing unit 51 may also be provided in each Web server 1. In this case, the call control device 7 previously allocates, to the respective Web servers 1, the phone numbers each issued as PhoneCookie by each Web server 1 in the phone numbers ensured to be incoming-enabled.

### Third Modified Example

The PhoneCookie issuing unit 51 may differentiate PhoneCookie (the number for user) issued for the user from PhoneCookie (the number for the call recipient) issued for the call recipient. Namely, two different PhoneCookies are associated to a single piece of contact request information, and the user and the call recipient are notified of PhoneCookies each having the different number. This scheme enables the user side and the call recipient side to use PhoneCookies of the different number systems.

Moreover, PhoneCookie, of which the user is notified, may be given a fixed number on a user-by-user basis. With this contrivance, a small number of PhoneCookies are sufficient for issuing. Further, if the user calls back, the user can be uniquely specified by PhoneCookie, thereby facilitating the data management.

PhoneCookie, when the valid period expires, obviates the association with the contact request information and is, when issuing PhoneCookie thereafter, associated with a new piece of contact request information.

Furthermore, PhoneCookie may be associated with not only the phone number issued by the PhoneCookie issuing unit 51 but also with the contact request information in the way of being combine with other information. For instance, the user's phone number is combined with the phone number issued by the PhoneCookie issuing unit 51, and the combined phone number is associated with the contact request information. Then, when receiving the incoming call addressed to the phone number as PhoneCookie from the user terminal 3, the phone number of the caller (the phone number of the user) is acquired, the associated contact request information is specified by a combination of these phone numbers. With this scheme, if the phone number of the user is different, the associative relation with the contact request information can be taken even by use of PhoneCookie of the same number, thereby enabling an issue count of PhoneCookies to be reduced.

Further, such a system may be taken that a range of the phone number issued as PhoneCookies to the call recipients is determined and the phone numbers are sequentially issued as PhoneCookies. Note that in the case of issuing the last phone number as PhoneCookie in the determined range, the PhoneCookie issuing unit 51 initializes the numbers to be issued and issues PhoneCookies subsequent to the first phone number by returning to this first phone number. At this time, if the application server 2 notifies the call recipient that the numbers are initialized, the call recipient can recognize whether the phone number is the pre-initializing PhoneCookie or the post-initializing PhoneCookie, and therefore, in the case of making the contact based on the pre-initializing PhoneCookie, the application server 2 is notified of the phone number being the pre-initializing PhoneCookie, whereby the post-initializing PhoneCookie is newly issued by the PhoneCookie issuing unit 51.

With this scheme, the phone numbers ensured for the specified call recipients can be reduced. Further, as described above, the determination of the range of the phone numbers facilitates the data management in the call recipients.

### Second Embodiment

In the first embodiment discussed above, the application server 2 transmits the access information to the terminal 5 as the inquired device via the network such as the Internet, however, by contrast a second embodiment takes a different configuration of transmitting the access information (query information) to a FAX terminal as an inquired device. Note that other configurations are the same, and hence the iterative explanations thereof are omitted in a way that marks the same components with the same reference numerals and symbols.

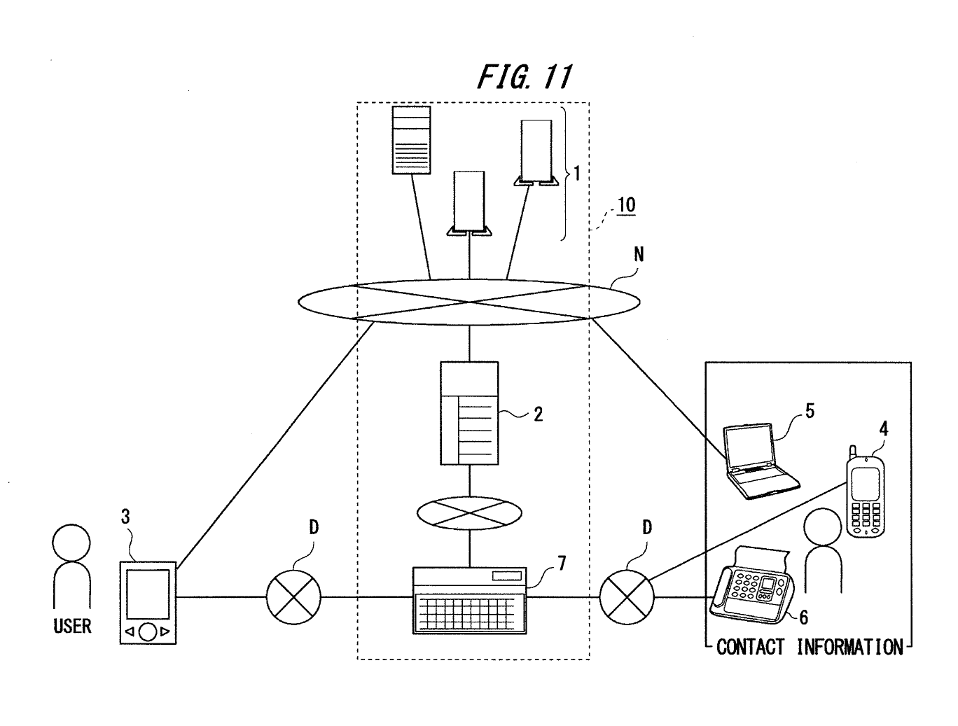

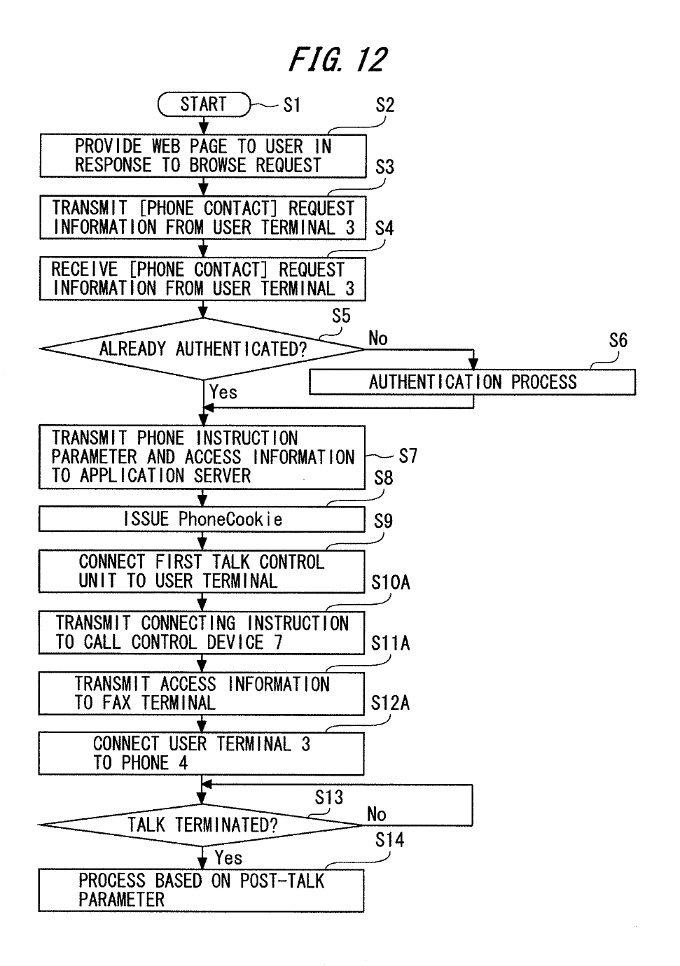

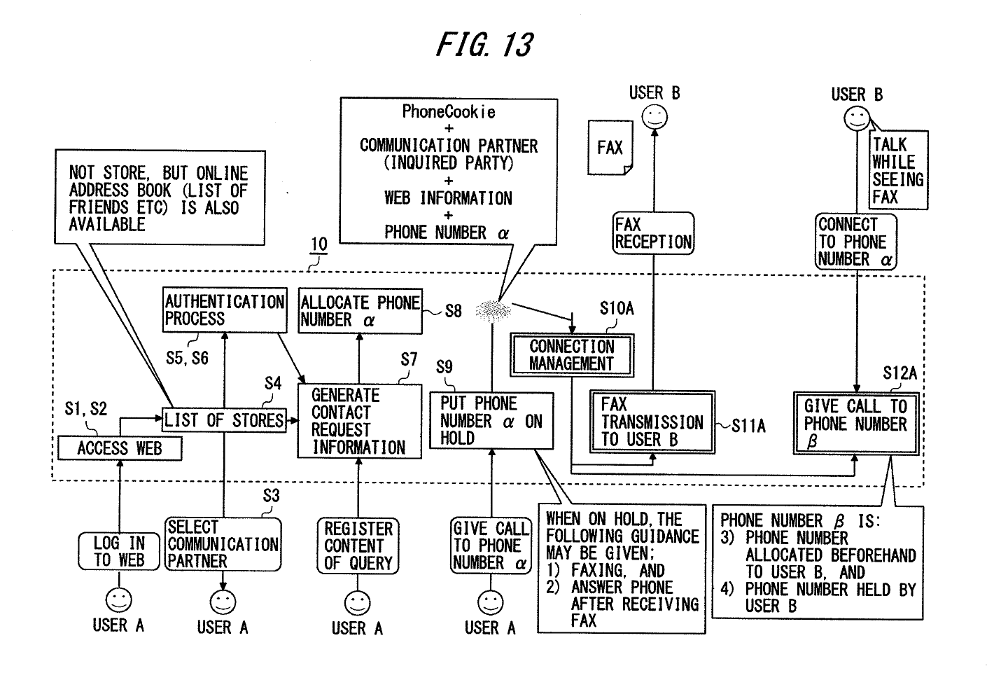

FIG. 11 is a schematic diagram of the access management system according to the second embodiment; FIG. 12 is a flowchart showing a flow of the whole process in which the access management system 10 transmits the query information to the user as the inquired party in response to a request given from the user as an inquirer; and FIG. 13 is an explanatory diagram of a process of transmitting the query information to the user as the inquired party.

As shown in FIG. 11, in the second embodiment, the inquired party (device) is equipped with a FAX terminal, and, when the inquirer user selects the “query”, the application server 2 converts the access information into image data and transmits the thus-converted image data to a FAX terminal 6 of the inquired party via the call control device 7.

An access management method executed by the access management system 10 will be described with reference to FIGS. 12-16.

As illustrated in FIGS. 12 and 13, the administration of the Web site is initiated (step S1), and the user terminal 3 makes a request for browsing the Web page in a way that specifies the URL, at which time the Web page providing unit 42 of the Web server 1 provides the Web page specified by the URL to the user terminal 3, whereby the Web page is displayed on the user terminal 3 (step S2). FIG. 6 is the diagram showing the display example of this Web page. FIG. 6 illustrates the example of the page for purchasing the commercial articles, in which the input box 61 for inputting the options and the [phone contact] link 62 are inserted.

When the link 62 is selected, the user terminal 3 transmits the request based on the parameter of the link 62, i.e., the information for requesting the [phone contact] to the Web server 1 (step S3).

The contact accepting unit 43, when receiving the information purporting the request for the contact by phone from the user terminal 3, gets the user terminal 3 to display an address list such as a list of stores and a list of friends and prompts the user to select the inquired party (step S4). Then, the contact accepting unit 43 determines, based on whether or not the session ID issued by the authentication processing unit 41 is received from the user terminal 3, whether the user terminal 3 has already been authenticated or not (step S5). If not already authenticated, the authentication processing unit 41 displays the log-in screen, then prompts the user to input the ID and the password, and executes the authentication process (step S6).

If already authenticated in step S5 and if already authenticated in step S6, the contact information generating unit 44 gets the user terminal 3 to display a query content registration screen (unillustrated), further gets the user to input from on the user terminal 3, and receives the query content. Then, the contact information generating unit 44 reads, in addition to the query content, the access information associated with the session ID and the phone instruction parameter associated with the inquired party from the storage unit 13, and generates and transmits the contact request information to the application server 2 (step S7). Note that the access information may be information on the user's access to the Web server 1 such as the URL of the Web page on which the [query by phone] link is selected, the data inputted to the Web page and the user's browse history of the Web page.

The PhoneCookie issuing unit 51 of the application server 2, which receives the contact request information from the Web server 1, issues a unique phone number corresponding to the contact request information as PhoneCookie and notifies the user terminal 3 (step S8).

After issuing PhoneCookie (the phone number α) and when the user terminal 3 makes the call to the phone number α, the call control device 7 receives this incoming call, sets this call in an on-hold status, then notifies the application server 2 of a purport that the call is given to the phone number α, and also notifies the user terminal 3 of voice messages such as [the transmission by FAX is being done] and [the talk will be started after the transmission by FAX] (step S9).

The access information providing unit 56 converts, based on the access information received from the Web server 1, the Web page accessed by the user terminal 3 and the query content into the image data. Further, the PhoneCookie issuing unit 51 allocates (issues) a unique phone number β for the inquired party in the way of being associated with the phone number α. This phone number β is contained in the image data or the phone instruction parameter as information for dialing. Then, the access information providing unit 56 transmits, to the call control device 7, the phone instruction parameter containing a FAX number of the inquired party together with the access information converted into the image data (step S10A).

The call control device 7 transmits the access information converted into the image data to the FAX terminal 6 via a telephone line D on the basis of the phone instruction parameter (step S11A).

The user as the inquired party receiving the Faxed information (image data) and dials the phone number β by seeing the Faxed information. Note that the phone number β may be, in step S10A, contained in the image data and transmitted in a status of being printed within the Faxed image and may also be contained in the phone instruction parameter as a FAX sender information and displayed as the phone number of the FAX sender. When dialing this phone number β from the phone 4, the call control device 7 receives the incoming call, and the second talk control unit 82 establishes the call with the phone 4. Then, the call control device 7 connects the phone number α associated with the phone number β, i.e., connects the on-hold call of the user terminal 3 to the call of the phone 4. Accordingly, the user terminal 3 and the phone 4 are set in the talk status by transmitting a voice received from the user terminal 3 to the phone 4 and transmitting a voice received from the phone 4 to the user terminal 3 (step S12A).

Moreover, the connection control unit 83, if the post-talk parameter is set in the phone instruction parameter, monitors the talk status, gives notification to the application server 2 when terminating the talk, and gets the post-talk processing unit 53 to execute the process based on the post-talk parameter (steps S13, S14). For example, upon the trigger of terminating the talk, the follow-up e-mail such as [Thank you for your query.] is transmitted, and the map of the store is transmitted.

Thus, according to the second embodiment, on the occasion of making the query by phone, the information used when accessing the Web page can be Faxed to the inquired party, and the user as the inquired party can receive the query while seeing the Faxed information, thereby facilitating the reciprocal communications.

Further, according to the second embodiment, the information used when accessing the Web page can be Faxed to the inquired party, whereby the query based on the present system can be given to a small-scale store etc which does not prepare an environment for establishing the connection with the network. Note that FIG. 11 illustrates an example in which the inquired party is provided with the user terminal 5 connectable to the application server 2 via the network, however, this user terminal 5 is assumed to execute a process having a not-so-high frequency such as registering the user information and executing a simple process on a smartphone etc. For instance, such a case is considered that if a spot (store etc) receiving the query is distanced from an office equipped with the user terminal 5, it is desired that a process having a low frequency such as registering the user information is executed by the user terminal 5 at the office and a daily process of receiving the query is executed by FAX at a store equipped with none of the user terminal. Further, the user terminal 5 of the inquired party is not indispensable, but the user terminal 5 in FIG. 11 may be omitted by executing the process such as the user registration by phone and by Fax.

### First Modified Example

The second embodiment discussed above may take a scheme of selectively determining whether the query is approved or not at such a stage that the user as the inquired party receives the information by FAX.

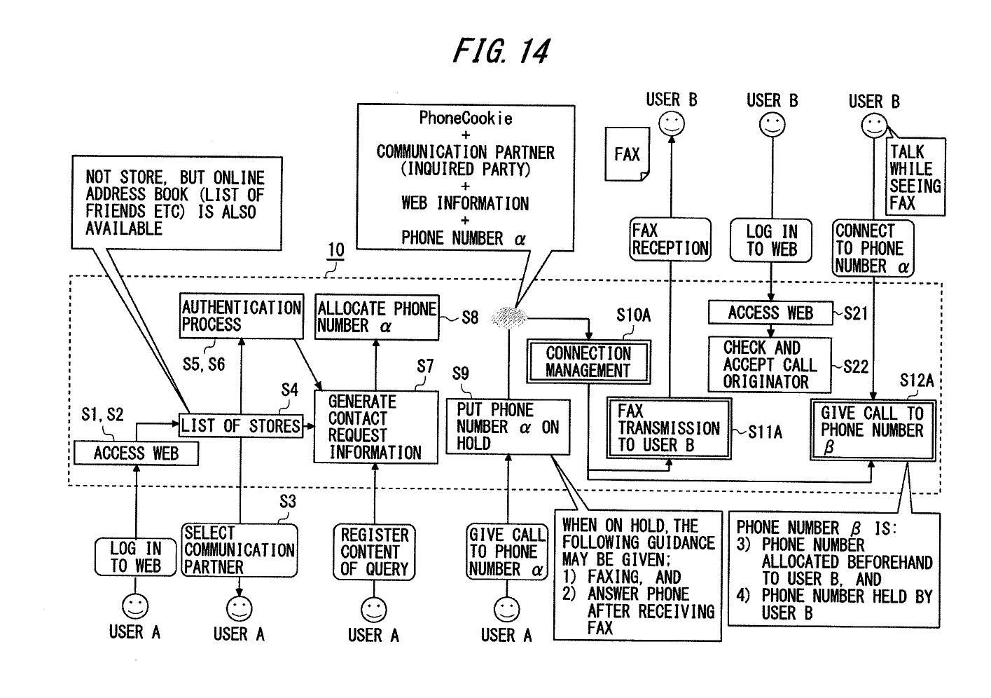

FIG. 14 is an explanatory diagram of a first modified example to take the scheme of selectively determining whether the query is approved or not. It is to be noted that the iterative explanations thereof are omitted in a way that marks the same components as those in the second embodiment with the same reference numerals and symbols.

In the same way as described above, the user as the inquired party receiving the information by FAX in step S11A accesses the application server 2 by operating the terminal 5 on the basis of, e.g., the Faxed information (step S21), and inputs “approval” or “non-approval” of the query (step S22).

If the query is approved, the application server 2 notifies the call control device 7 of the approval, and, similarly to the second embodiment discussed above, upon receiving the call originated from the phone 4 of the inquired party, executes the subsequent process by connecting the call of the phone 4 to the call of the user terminal 3.

Whereas if the query is not approved, the application server 2 notifies the call control device 7 of the non-approval and transmits a voice message purporting “being disable from connecting” such as [The phone is hard to get a connection at the present.], [It is out of business hours.], etc to the on-hold user terminal 3, thus stopping the subsequent process.

Note that in step S21, in order for the user as the inquired party to access the application server 2, the Faxed information may contain the information for the contact for authentication, e.g., the URL and a QR (Quick Response) code. The user accesses the application server 2 by inputting this URL to Browser. Alternatively, an image of the QR code is captured by a camera and converted into URL, and the user accesses the application server 2 by use of this URL.

Moreover, the information of the contact for authentication may be, without being limited to FAX, transmitted to the user terminal 5 by SMS (Short Message Service) and e-mail.

Further, another available scheme is not that the information for calling is transmitted on a per-query basis but that URL of a portal site etc is predetermined, then the access to this URL is done, the log-in to this site is attained by inputting the user identifying information such as the phone number, and the approval or non-approval about the query associated with this identifying information is inputted.

Furthermore, still another available scheme is that without being limited to the access via the network, the approval or the non-approval is inputted to an IVR (Interactive Voice Response) system by dialing the phone number (the information for the contact for authentication) registered in the Faxed information or the specified phone number from the phone 4, thereby notifying the application server of the information of the approval or non-approval. Moreover, if there is no access within a predetermined period of time, the non-approval may be determined.

As described above, according to the first modified example, it is feasible to reject the talk in response to the query on holidays and out of business hours.

### Second Modified Example

The first modified example takes the scheme of dialing from the user side, however, a scheme of dialing from the system side may also be taken.

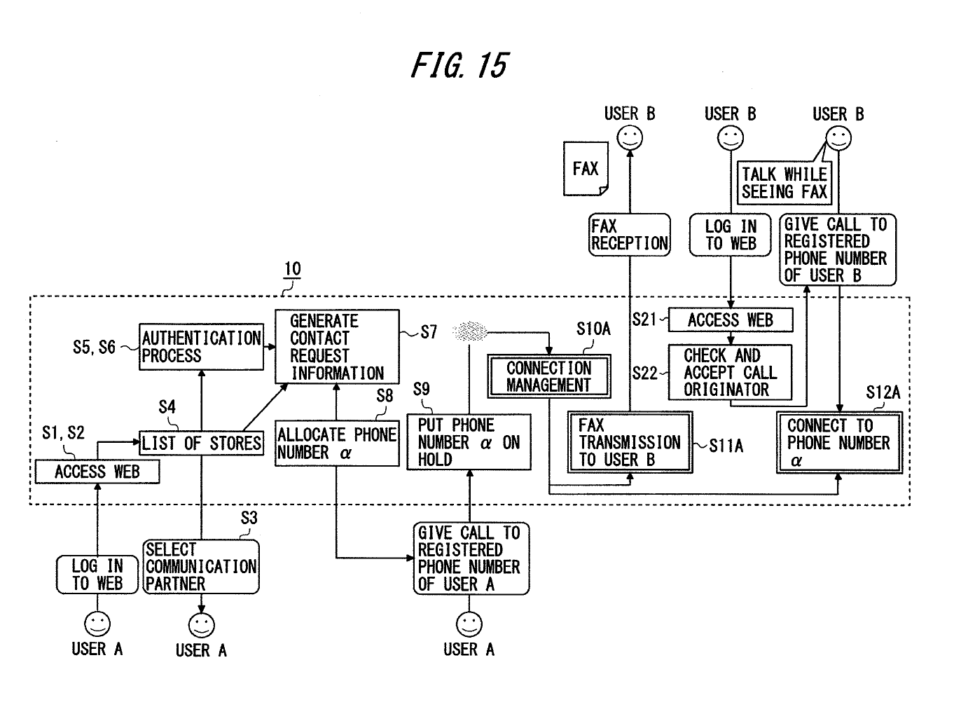

FIG. 15 is an explanatory diagram of the second modified example of taking the scheme of giving the call to the user from the side of the access management system 10. Note that the iterative explanations thereof are omitted in a way that marks the same components as those in the first modified example discussed above with the same reference numerals and symbols.

The PhoneCookie issuing unit 51 of the application server 2, which receives the contact request information from the Web server 1, issues the unique phone number α associated with the contact request information as PhoneCookie and notifies the call control device 7 of this phone number α, at which time the first talk control unit 81 of the call control device 7 uses the phone number α as a phone number of the originator and dials the phone number of the user terminal 3, thereby establishing the call with the user terminal 3 (step S8A).

Then, the call control device 7 establishing the call sets this call in a on-hold status, then notifies the application server 2 of a purport that the call related to the phone number α (PhoneCookie) is established and also notifies the user terminal 3 of voices messages such as [It is being Faxing] and [The talk will be started after Faxing] (step S9). The application server 2 notified of the call being established executes the processes subsequent to step S10A in the same way as the case of receiving the notification of dialing the phone number α as described above.

Moreover, if the “approval” is inputted in step S22A, the application server 2 notifies the call control device 7 of this purport, while the second talk control unit 82 of the call control device 7 dials the phone number of the phone 4 of the inquired party on the basis of the phone instruction parameter, thus establishing the call with the phone 4. Then, the call control device 7 connects the call of the user terminal 3 set in the on-hold status to the call of the phone 4, and executes the subsequent processes in the same way as in the first modified example discussed above.

As described above, according to the second modified example, convenience for the user can be improved by reducing a time-consuming operation of telephoning from the user.

### Third Modified Example

In the second modified example discussed above, the call of the user as the inquirer is kept in the on-hold status till the inquired party answers, however, without being limited to this scheme, such an available scheme may be taken that the user as the inquired party receives the Faxed information and makes the call, in which case the user as the inquirer receives this call.

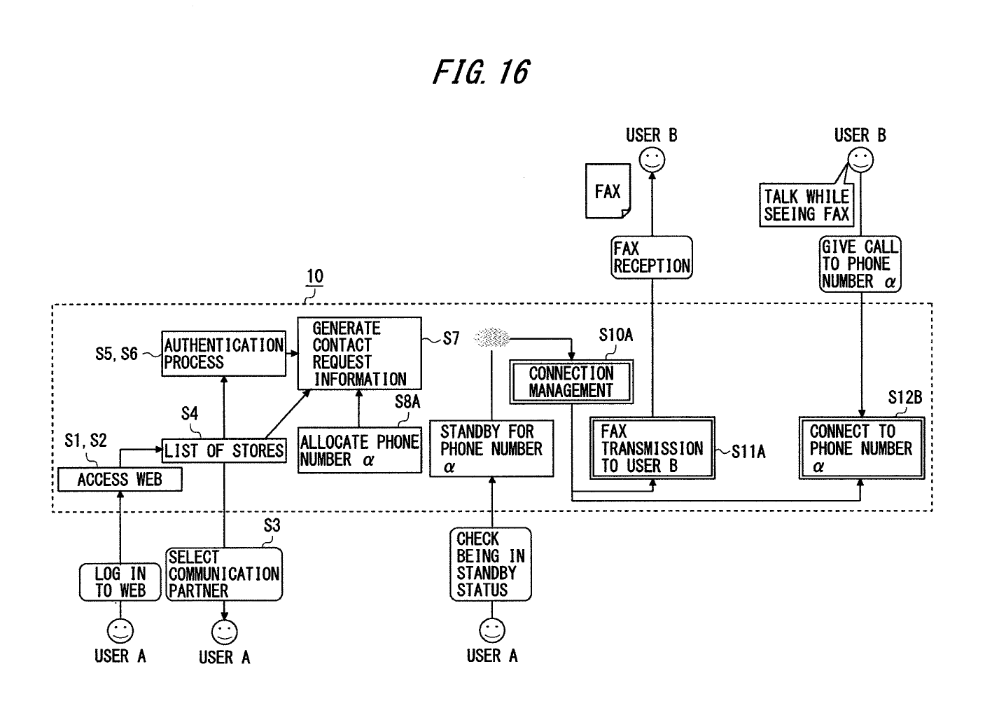

FIG. 16 is an explanatory diagram of a third modified example having a scheme of making the call to the inquirer in the case of being telephoned from the inquired party. Note that the iterative explanations thereof are omitted in a way that marks the same components as those in the second modified example discussed above with the same reference numerals and symbols.

In the same way as described above, in the case of receiving the contact request information from the Web server 1 (step S7), the PhoneCookie issuing unit 51 issues the unique phone number α as PhoneCookie associated with this contact request information (step S8A) and moves to step S10A without connecting the call with the user terminal 3. Accordingly, the user terminal 3 comes to a status of waiting for the contact from the inquired party, i.e., comes to a standby status. At this time, the user terminal 3 accesses the predetermined URL of the application server 2, e.g., logs in to the portal site, whereby there may be displayed statuses such as “It is being Faxed”, “On-talk” (on-standby because the phone or the FAX of the inquired party is busy) and “Standby status” (waiting for the contact from the inquired party). Further, without being limited to this scheme, the user terminal 3 and the phone 4 may be notified of these statuses by SMS and e-mail.

The access information providing unit 56 of the application server 2, on the occasion of Faxing the information to the inquired party (step S11A), notifies the FAX terminal 6, the user terminal 5 or the phone 4 of the inquired party of, e.g., the phone number α as the information for calling.

Then, when (the user of) the phone 4 of the inquired party makes the call to the phone number α, the second talk control unit 82 of the call control device 7 receives the incoming call, and the connection control unit 83 notifies the call control linkage unit 52 of the application server 2 of a purport that there is the incoming call addressed to PhoneCookie. The call control linkage unit 52 reads the phone number of the inquirer, which is associated with this PhoneCookie. Namely, the PhoneCookie issuing unit 51 reads, from the memory or the storage unit 23, the user's phone number contained in the phone instruction parameter received from the Web server 1 in step S7 when the PhoneCookie issuing unit 51 allocates (issues) the phone number α. Then, the call control linkage unit 52 notifies the call control device 7 of the phone instruction parameter showing a purport of connecting the call to the readout phone number of the inquirer. The first talk control unit 81 of the call control device 7 makes the call to the phone number of the call recipient on the basis of this phone instruction parameter, thereby establishing the call with the user terminal 3. Then, the connection control unit 83 connects the call of the second talk control unit 82 from the phone 4 to the call of the user terminal 3 from the first talk control unit 81, thereby setting the user terminal 3 and the phone 4 of the call recipient in the talk status (step S12B).

As described above, according to the third modified example, there is no necessity for setting the call of the user terminal 3 in the on-hold status till the user terminal 3 of the inquirer is connected to the phone 4 of the inquired party, whereby the time may be short enough to keep the call. Further, the convenience for the user as the inquirer is improved without restraining the user as the inquirer due to the on-hold status.

### <Others>

The present invention is not limited to only the illustrative examples described above but may be, as a matter of course, modified in a variety of forms within the range that does not deviate from the gist of the present invention.

What is claimed is:

1. An access management system comprising:
a Web page providing unit to transmit a Web page to a user terminal when receiving a request for browsing the Web page from the user terminal by a user's operation;
a contact accepting unit to receive, when the user selects an option of a contact by phone in options described on the Web page, information purporting a request for the contact from the user terminal;
a contact information generating unit to generate, when receiving the information purporting the request for the contact, at least information of the Web page browsed by the user as access information;
a contact number issuing unit to issue a phone number for contact which is associated with the access information;
a first talk control unit making a call to a phone of the user on the basis of the user's phone number specified by an input operation of the user and notifying of the contact phone number as an originator number or receiving a call originated from the phone of the user and addressed to the contact phone number;
a second talk control unit to make the call to a phone of a call recipient which is associated with the access information;
a connection control unit to connect the call of the phone of the user to the call of the phone of the call recipient; and
an access information providing unit to transmit the access information to a terminal provided at the call recipient via a network.

2. The access management system according to claim 1, wherein when the first talk control unit receives the call addressed to the contact phone number from the phone of the user, the second talk control unit makes the call to the phone of the call recipient which is associated with the contact phone number, and
the connection control unit connects the call of the first talk control unit to the call of the second talk control unit.

3. The access management system according to claim 1, wherein the contact number issuing unit issues a contact phone number for the call recipient, which is different from the contact phone number associated with the access information in the way of being associated with the access information.

4. The access management system according to claim 1, wherein the access information providing unit transmits the access information to a facsimile terminal provided at the call recipient via a telephone line.

5. An access management method by which a computer executes:
transmitting a Web page to a user terminal when receiving a request for browsing the Web page from the user terminal by a user's operation;
receiving, when the user selects an option of a contact by phone in options described on the Web page, contact request information from the user terminal;
generating, when receiving the contact request information, at least information of the Web page browsed by the user as access information;
issuing a phone number for contact which is associated with the access information;
making a call to a phone of the user on the basis of the user's phone number specified by an input operation of the user and notifying of the contact phone number as an originator number or receiving a call originated from the phone of the user and addressed to the contact phone number;
making the call to a phone of a call recipient which is associated with the access information;
connecting the call of the phone of the user to the call of the phone of the call recipient; and
transmitting the access information to a terminal provided at the call recipient via a network.

6. The access management method according to claim 5, wherein when receiving the call addressed to the contact phone number from the phone of the user, the call is given to the phone of the call recipient which is associated with the contact phone number, and
the call of the user terminal is connected to the call of the phone of the inquired party.

7. The access management method according to claim 5, wherein a contact phone number for the call recipient, which is different from the contact phone number associated with the access information, is issued for the call recipient in the way of being associated with the access information.

8. The access management method according to claim 5, wherein the access information is transmitted to a facsimile terminal provided at the call recipient via a telephone line.
